(19) United States
(12) Patent Application Publication
(10) Pub. No.: US 2016/0226075 A1
(43) Pub. Date: Aug. 4, 2016

(54) CATALYST FOR FUEL CELL, METHOD OF PREPARING SAME, AND MEMBRANE-ELECTRODE ASSEMBLY FOR FUEL CELL INCLUDING SAME

(71) Applicant: SAMSUNG SDI CO., LTD., Yongin-si (KR)

(72) Inventors: Myoung-Ki MIN, Yongin-si (KR); Eun-Young YOU, Yongin-si (KR); Nak-Won KONG, Yongin-si (KR)

(21) Appl. No.: 14/876,388

(22) Filed: Oct. 6, 2015

(30) Foreign Application Priority Data
Feb. 2, 2015 (KR) 10-2015-0016358

(51) Int. Cl. H01M 4/90; H01M 8/1004

(52) U.S. Cl. CPC H01M 4/9016; H01M 4/9083; H01M 8/1004; H01M 2250/20

(57) ABSTRACT

A catalyst for a fuel cell includes an oxide represented by the following Chemical Formula 1 and a reaction-induced material including SiO₂, a method of preparing the same, and a membrane-electrode assembly for a fuel cell including the same are disclosed.

IrₐRu_{b}Oₓ [Chemical Formula 1]

In Chemical Formula 1, a, b and x are the same as defined in the detailed description.

### INCORPORATION BY REFERENCE TO ANY PRIORITY APPLICATIONS

Any and all priority claims identified in the Application Data Sheet, or any correction thereto, are hereby incorporated by reference under 37 CFR 1.57.

This application claims priority to and the benefit of Korean Patent Application No. 10-2015-0016358 filed in the Korean Intellectual Property Office on Feb. 2, 2015, the disclosure of which is incorporated in the entirety by reference.

### BACKGROUND

1. Field

This disclosure relates to a catalyst for a fuel cell, a method of preparing the same, and membrane-electrode assembly for a fuel cell including the same.

2. Description of the Related Technology

Examples of a fuel cell are a polymer electrolyte membrane fuel cell (PEMFC) and a direct oxidation fuel cell (DOFC). A direct oxidation fuel cell which uses methanol as a fuel is called to be a direct methanol fuel cell (DMFC).

The direct oxidation fuel cell has a lower energy density than the polymer electrolyte fuel cell but an advantage of easy handling of liquid-type fuel, being operated at a low temperature, and requiring no additional fuel reforming processor. The polymer electrolyte fuel cell has an advantage of having high energy density and power.

In the above fuel cell, the stack that actually generates electricity includes several to scores of unit cells stacked in multi-layers. Each unit cell is made up of a membrane-electrode assembly (MEA) and a separator (also referred to as a bipolar plate). The membrane-electrode assembly has an anode (referred to as a fuel electrode or an oxidation electrode) and a cathode (referred to as an air electrode or a reduction electrode) attached to each other with an electrolyte membrane therebetween.

Fuel is supplied to an anode and adsorbed on catalysts of the anode, and then, oxidized to produce protons and electrons. The electrons are transferred into the anode, a reducing electrode, via an external circuit to the cathode, while the protons are transferred to the cathode through the polymer electrolyte membrane. In addition, an oxidant is supplied to the cathode. Then, the oxidant, protons, and electrons are reacted on catalysts of the cathode to produce electricity along with water.

When this fuel cell is used for a car, a composition of gas may include oxygen and hydrogen at the anode which causes an increase in the voltage at the cathode up to greater than or equal to about 1.6 V during start-up/shut-down of the car or during a fuel shortage.

In this way, when a high voltage is applied to the cathode, carbon used as a carrier of a fuel cell catalyst starts to be corroded and becomes sharply corroded at greater than or equal to about 1 V.

### SUMMARY

One embodiment provides a catalyst for a fuel cell being capable of preventing corrosion of a carrier and having high activity and stability and thereby improving cell performance.

Another embodiment provides a method of preparing the catalyst for a fuel cell.

Yet another embodiment provides a membrane-electrode assembly for a fuel cell including the catalyst for a fuel cell.

One embodiment provides a catalyst for a fuel cell including an oxide represented by the following Chemical Formula 1 and a reaction-induced material including SiO₂.

IrₐRu_{b}Oₓ Chemical Formula 1

In Chemical Formula 1,

the a/b ratio ranges from about 0.3 to about 3.5, and x is an integer of about 0.5 to about 2.

In the oxide of the Chemical Formula 1, the a/b ratio may range from about 0.5 to about 2.

The oxide may have the shape of a nano particle, a nano rod, a core-shell or a combination thereof.

The oxide may have an average particle diameter (D50) of about 1 nm to about 6 nm.

The catalyst may further include a carrier supporting the oxide.

The SiO₂ may be included in an amount of about 0.5 wt % to about 5 wt % based on the total amount of the oxide and the carrier.

The carrier may include graphite, denka black, ketjen black, acetylene black, carbon nanotube, carbon nano fibers, carbon nano wires, carbon nano balls, activated carbon, stabilized carbon, indium tin oxide (ITO), TiO₂, WO, SiO₂, or a combination thereof.

The sum of the oxide and the SiO₂ may be included in an amount of about 20 wt % to about 99 wt % based on the total amount of the oxide, the SiO₂ and the carrier.

The catalyst may further include an active material including a metal.

The active material may further include a carrier supporting the metal.

The metal may be included in an amount of about 10 wt % to about 80 wt % based on the total amount of the metal and the carrier.

The oxide may be included in an amount of about 0.5 parts by weight to about 10 parts by weight based on 100 parts by weight of the active material.

Another embodiment provides a method of preparing a catalyst for a fuel cell that includes mixing an iridium precursor and a ruthenium precursor so that an Ir/Ru atomic ratio is about 0.3 to about 3.5 and adding SiO₂ thereto to obtain a mixture; subjecting the mixture to a first heat treatment; subjecting the first heat-treated mixture to a second heat treatment; and removing at least one part of the SiO₂ from the second heat treated mixture to prepare an oxide represented by the Chemical Formula 1, and a reaction-induced material including SiO₂.

The mixture may further include a carrier.

The first heat treatment may be performed under a hydrogen atmosphere at a temperature of about 150° C. to about 500° C., and the second heat treatment may be performed under an air atmosphere at a temperature of about 200° C. to about 500° C.

Another embodiment provides a membrane-electrode assembly for a fuel cell that includes a cathode and an anode facing each other; and a polymer electrolyte membrane between the cathode and anode, wherein the cathode and the anode respectively include an electrode substrate and a catalyst layer disposed on the electrode substrate and including the catalyst.

Other embodiments are included in the following detailed description.

The catalyst prevents corrosion of the carrier and itself has high stability, and thereby a fuel cell having improved cell performance may be achieved.

### BRIEF DESCRIPTION OF THE DRAWINGS

FIG. 1 is a schematic view of a membrane-electrode assembly (MEA) for a fuel cell according to one embodiment.

FIG. 2 is an exploded perspective view of a fuel cell stack according to one embodiment.

FIG. 3 is a graph showing an electrochemical phenomenon generated in a car using a fuel cell during the start-up/shut-down cycles.

FIG. 4 is graph showing current density of membrane-electrode assembly according to Comparative Example 1 depending on a start-up/shut-down cycle.

FIG. 5 is graph showing current density of membrane-electrode assembly according to Example 1 depending on a start-up/shut-down cycle.

FIG. 6 is graph showing current density of membrane-electrode assembly according to Comparative Example 2 depending on a start-up/shut-down cycle.

FIG. 7 is a graph showing current density of membrane-electrode assembly according to Example 3 depending on a start-up/shut-down cycle.

FIG. 8 is a graph showing electrochemical surface area change of each catalyst layer according to Example 1 and Comparative Example 1 depending on the number of a start-up/shut-down cycle.

FIG. 9 is a graph showing the cyclic voltage-current of each catalyst layer according to Comparative Example 2 and Example 3.

FIG. 10 is a graph showing the cyclic voltage-current of the catalyst layer according to Example 3 depending on the number of a start-up/shut-down cycle.

FIG. 11 is a graph showing water decomposition performance of each catalyst layer according to Examples 4 to 6 and Comparative Examples 3 to 5 in a range of 1.4 V and 1.6 V.

FIG. 12 is a graph showing the voltage-current of each catalyst layer according to Example 1 and Comparative Example 6.

### DETAILED DESCRIPTION

Hereinafter, embodiments are described in detail. However, these embodiments are only exemplary, and this disclosure is not limited thereto.

As used herein, when specific definition is not otherwise provided, It will be understood that when an element such as a layer, film, region, or substrate is referred to as being “on” another element, it can be directly on the other element or intervening elements may also be present.

A catalyst for a fuel cell according to one embodiment includes an oxide represented by the following Chemical Formula 1, and a reaction-induced material.

IrₐRu_{b}Oₓ Chemical Formula 1

The oxide represented by the Chemical Formula 1 has high water decomposition activity due to ruthenium (Ru) element and high voltage stability due to iridium (Ir) element and thus, may improve durability about carrier corrosion.

In addition, the oxide may drive and promote a reaction of decomposing water at a high voltage thus generating hydrogen and oxygen, for example, an oxygen evolution reaction (OER). A carrier such as carbon may be corroded by an increased voltage at a cathode during the start-up/shut-down of a car or during a fuel shortage, but a large oxygen evolution reaction may decompose water instead of corroding a carrier at a high voltage and also decrease or prevent the carrier corrosion.

In the Chemical Formula 1, the a/b ratio may range from about 0.3 to about 3.5, and specifically about 0.5 to about 2. When an oxide having a composition of an Ir/Ru atomic ratio within the range is used as a catalyst for a fuel cell, the catalyst has high water decomposition activity and excellent stability at a high voltage and thus, improves cell performance.

In the Chemical Formula 1, x may be an integer of about 0.5 to about 2, and specifically about 1 to about 2. When the value of x is within the range, stable performance may be obtained without changing the water decomposition activity at a high voltage.

The oxide may have the shape of a nano particle, a nano rod, a core-shell or a combination thereof. The oxide having the above shape may have high dispersion.

The oxide may have an average particle diameter (D50) of about 1 nm to about 6 nm, specifically about 2 nm to about 5 nm. When the oxide has an average particle diameter within the range, the dispersion may be further improved, and thus, high activity may be obtained in its small amount.

The catalyst may further include a carrier supporting the oxide. In other words, the oxide represented by the Chemical Formula 1 may be used alone or supported by a carrier. Among these two uses, for example, the oxide may be supported by a carrier in terms of increasing dispersion of a catalyst.

The carrier may include graphite, denka black, ketjen black, acetylene black, carbon nanotube, carbon nano fibers, carbon nano wires, carbon nano balls, activated carbon, stabilized carbon, indium tin oxide (ITO), TiO₂, WO, SiO₂, or a combination thereof.

The stabilized carbon may be formed by heat-treating carbon black such as ketjen black at about 1500° C. to about 3000° C., for example, at about 2000° C. to about 2800° C. The stabilized carbon has a surface area ranging from about 50 m²/g to about 700 m²/g, for example, about 70 m²/g to about 400 m²/g.

The sum of the oxide and the reaction-induced material that may be included in an amount of about 20 wt % to about 99 wt %, for example, about 30 wt % to about 80 wt %, about 30 wt % to about 70 wt % based on the total amount of the oxide, the reaction-induced material and the carrier.

When the amount of the oxide and the reaction-induced material is within the range, high stability may be secured, and dispersion of a catalyst may be improved.

The reaction-induced material may include SiO₂.

The SiO₂ may play a role of an initiator of initiating the above oxygen evolution reaction. In other words, the initiator initiates the oxygen evolution reaction at a lower voltage and may further lower an initiation voltage. Accordingly, when the SiO₂ is used in the electrode of the fuel cell, the oxygen evolution reaction easily occurs at a low voltage and thus, may secure high activity and stability and further prevent corrosion of the carrier.

The SiO₂ may be included in an amount of about 0.5 wt % to about 5 wt %, specifically about 1 wt % to about 3 wt %, based on the total amount of the oxide and the carrier. When the SiO₂ is included within this range, the water decomposition reaction is initiated at a lower voltage, and thus, high activity and stability of a fuel cell catalyst may be obtained, and corrosion of a carrier may be further prevented.

The reaction-inducing material may be present by supporting on the oxide.

The catalyst may be prepared in accordance with the following method:

The method includes mixing an iridium precursor and a ruthenium precursor so that an Ir/Ru atomic ratio is about 0.3 to about 3.5, optionally further mixing a carrier therewith, and adding SiO₂ thereto to obtain a mixture; subjecting the mixture to a first heat treatment; subjecting the first heat-treated mixture to a second heat treatment; and removing at least one part of the SiO₂ from the second heat treated mixture to prepare an oxide represented by the Chemical Formula 1, and a reaction-induced material including SiO₂.

The iridium precursor may be hexachloroiridic acid (H₂IrCl₆), and the like, and the ruthenium precursor may be ruthenium chloride (RuCl₃), and the like.

The first heat treatment may be performed under a hydrogen atmosphere at a temperature of about 150° C. to about 500° C., for example, about 200° C. to about 400° C. The second heat treatment may be performed under an air atmosphere at a temperature of about 200° C. to about 500° C., for example about 225° C. to about 300° C.

The SiO₂ may be removed by using a base such as NaOH, KOH and the like or HF acid.

According to one embodiment, a catalyst for a fuel cell may include an active material other than the above reaction-induced material.

The active material may include a metal.

The metal may be specifically a platinum-based metal. The platinum-based metal may include, specifically platinum, ruthenium, osmium, a platinum-M alloy (M is at least one metal selected from Ga, Ti, V, Cr, Mn, Fe, Co, Ni, Cu, Zn, Sn, Mo, W, Rh, Ru, Os and Pd), or a combination thereof. The platinum-based metal may include, more specifically, Pt, a Pt—Ru alloy, a Pt—W alloy, a Pt—Ni alloy, a Pt—Sn alloy, a Pt—Mo alloy, a Pt—Pd alloy, a Pt—Fe alloy, a Pt—Cr alloy, a Pt—Co alloy, a Pt—Co—Ni alloy, a Pt—Co—Fe alloy, a Pt—Co—S alloy, a Pt—Fe—S alloy, a Pt—Co—P alloy, a Pt—Fe—S alloy, a Pt—Fe—Ir alloy, a Pt—Co—Ir alloy, a Pt—Cr—Ir alloy, a Pt—Ni—Ir alloy, a Pt—Au—Co alloy, a Pt—Au—Fe alloy, a Pt—Au—Fe alloy, a Pt—Au—Ni alloy, a Pt—Ru—W alloy, a Pt—Ru—Mo alloy, a Pt—Ru—V alloy, a Pt—Ru—Rh—Ni alloy, a Pt—Ru—Sn—W alloy, or a combination thereof.

The active material may further include a carrier supporting the metal. In other words, the metal may be used alone as the active material or supported by the carrier.

The carrier may include graphite, denka black, ketjen black, acetylene black, carbon nanotube, carbon nano fibers, carbon nano wires, carbon nano balls, activated carbon, stabilized carbon, indium tin oxide (ITO), TiO₂, WO, SiO₂, or a combination thereof.

When the metal is supported on the carrier, the metal may be included in an amount of about 10 wt % to about 80 wt %, and specifically about 20 wt % to about 65 wt % based on the total amount of the metal and the carrier. When the metal is supported within the range, a fuel cell having high activity may be secured and manufacture of a catalyst layer may be facilitated.

The oxide represented by the Chemical Formula 1 may be included in an amount of about 0.5 parts by weight to about 10 parts by weight, for example, about 1 part by weight to about 7.5 parts by weight based on 100 parts by weight of the active material, specifically the sum of the metal and the carrier. When the oxide is included within the range, a catalyst for a fuel cell may have excellent stability at high voltages through high water decomposition activity without deteriorating performance of a conventional membrane-electrode assembly in a small amount of a noble metal.

According to one embodiment, an electrode for a fuel cell including the catalyst is provided.

Specifically, the electrode for a fuel cell includes an electrode substrate and a catalyst layer supported on the electrode substrate.

The catalyst layer includes the catalyst, and may further include an ionomer to improve adherence and proton transfer properties of the catalyst layer.

The ionomer may be a polymer resin having proton conductivity and specifically a polymer resin having a cation exchange group selected from a sulfonic acid group, a carboxylic acid group, a phosphoric acid group, a phosphonic acid group, and derivatives thereof at its side chain. Specifically, the ionomer may be at least one polymer resin selected from a fluorine-based polymer, a benzimidazole-based polymer, a polyimide-based polymer, a polyetherimide-based polymer, a polyphenylenesulfide-based polymer, a polysulfone-based polymer, a polyethersulfone-based polymer, a polyetherketone-based polymer, polyether-etherketone-based polymer, and a polyphenylquinoxaline-based polymer.

More specifically, the ionomer may be at least one polymer resin selected from poly(perfluorosulfonic acid), poly(perfluorocarboxylic acid), a copolymer of tetrafluoroethylene having a sulfonic acid group and fluorovinylether, sulfide polyetherketone, aryl ketone, poly(2,2′-m-phenylene)-5,5′-bibenzimidazole and poly(2,5-benzimidazole).

The hydrogen (H) ion in the cation exchange group of the polymer resin having proton conductivity may be substituted with Na, K, Li, Cs, or tetrabutylammonium ions. When the H in the cation exchange group of the terminal end of the side chain is substituted with Na or tetrabutylammonium ions, NaOH or tetrabutylammonium hydroxide may be used during preparation of the catalyst composition, respectively. When the H ion is substituted with K, Li, or Cs, suitable compounds for the substitutions may be used. Since such a substitution is known to this art, a detailed description thereof is omitted.

The ionomer may be used alone or in combination. They may be used along with a non-conductive compound to improve adherence with a polymer electrolyte membrane. The non-conductive compound may be used in a controlled amount to adapt to its purpose.

Examples of the non-conductive compound may be at least one selected from group consisting of polytetrafluoroethylene (PTFE), a tetrafluoroethylene-hexafluoropropylene copolymer (FEP), a tetrafluoroethylene-perfluoro alkylvinylether copolymer (PFA), ethylene/tetrafluoroethylene (ETFE), an ethylenechlorotrifluoro-ethylene copolymer (ECTFE), polyvinylidene fluoride, a polyvinylidene fluoride-hexafluoropropylene copolymer (PVdF-HFP), dodecylbenzenesulfonic acid, and sorbitol.

The ionomer may be included in an amount of about 15 wt % to about 50 wt %, and specifically about 20 wt % to about 40 wt % based on the total amount of the catalyst layer. When the ionomer is included within the range, adherence of the catalyst layer is improved, and proton transfer efficiency is increased.

The electrode substrate plays a role of supporting an electrode and diffusing a fuel and an oxidant into a catalyst layer, so that the fuel and the oxidant can easily approach the catalyst layer.

The electrode substrates are formed from a material such as carbon paper, carbon cloth, carbon felt, or a metal cloth (a porous film composed of metal fiber or a metal film disposed on a surface of a cloth composed of polymer fibers). The electrode substrate is not limited thereto.

The electrode substrates may be treated with a fluorine-based resin to be water-repellent to prevent deterioration of diffusion efficiency due to water generated during operation of a fuel cell.

The fluorine-based resin may be one selected from polytetrafluoroethylene, polyvinylidene fluoride, polyhexafluoropropylene, polyperfluoroalkylvinylether, polyperfluorosulfonylfluoride alkoxyvinyl ether, fluorinated ethylene propylene, polychlorotrifluoroethylene, and a copolymer thereof.

In order to increase reactant diffusion effects between the electrode substrates and catalyst layer, the anode or cathode may further include a microporous layer on an electrode substrate.

The microporous layer generally includes conductive powders with a certain particle diameter. The conductive material may include, but is not limited to, carbon powder, carbon black, acetylene black, activated carbon, a carbon fiber, fullerene, carbon nanotubes, carbon nanowires, carbon nanohorns, carbon nanorings, or combinations thereof.

According to one embodiment, a membrane-electrode assembly for a fuel cell including the electrode for a fuel cell is provided.

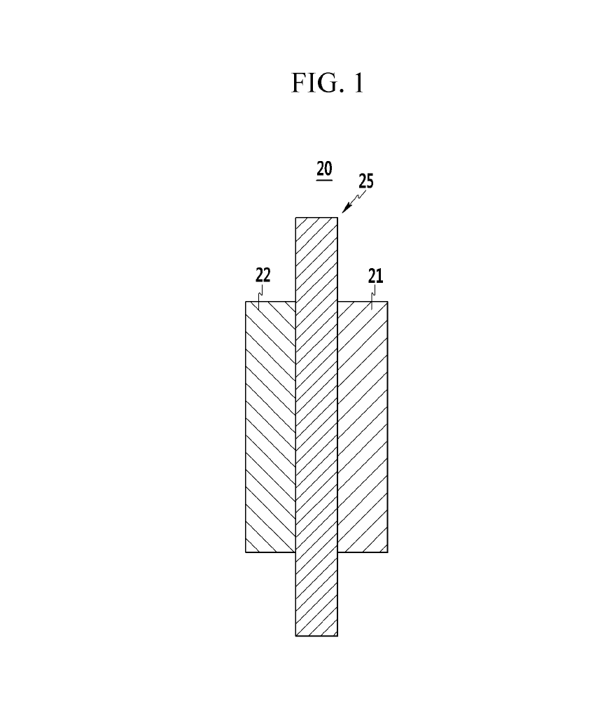

The membrane-electrode assembly for a fuel cell is described referring to FIG. 1.

FIG. 1 is a schematic view of a membrane-electrode assembly (MEA) for a fuel cell according to one embodiment.

Referring to FIG. 1, a membrane-electrode assembly 20 for a fuel cell includes a polymer electrolyte membrane 25 and a cathode 21 and an anode 22 positioned at both sides of the polymer electrolyte membrane 25.

At least one of the cathode 21 and the anode 22 includes the electrode for a fuel cell.

The polymer electrolyte membrane 25 is a solid polymer electrolyte having a thickness of about 10 μm to about 200 μm, and functions as an ion-exchange medium of transferring protons produced at a catalyst layer of an anode to a catalyst layer of a cathode.

The polymer electrolyte membrane 25 may be any generally-used polymer electrolyte membrane made of a proton conductive polymer resin. The proton conductive polymer resin may be a polymer resin having a cation exchange group selected from a sulfonic acid group, a carboxylic acid group, a phosphoric acid group, a phosphonic acid group, and derivatives thereof, at its side chain.

Examples of the polymer resin include at least one selected from a fluorine-based polymer, a benzimidazole-based polymer, a polyimide-based polymer, a polyetherimide-based polymer, a polyphenylenesulfide-based polymer, a polysulfone-based polymer, a polyethersulfone-based polymer, a polyetherketone-based polymer, a polyether-etherketone-based polymer, and a polyphenylquinoxaline-based polymer, and more specific examples may be poly(perfluorosulfonic acid) (commercially available as “NAFION”), poly(perfluorocarboxylic acid), a copolymer of tetrafluoroethylene having a sulfonic acid group and fluorovinylether, defluorinated sulfide polyetherketone, aryl ketone, poly[(2,2′-m-phenylene)-5,5′-bibenzimidazole], and poly (2,5-benzimidazole).

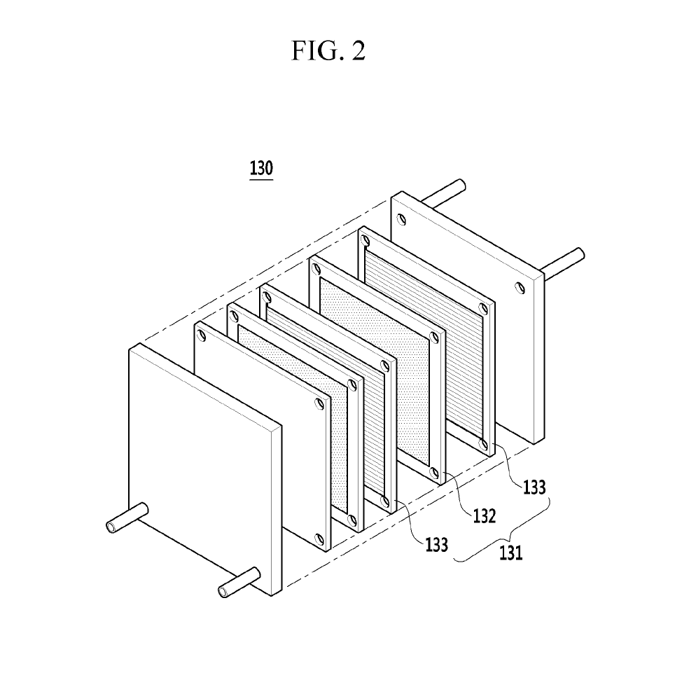

The fuel cell includes a stack where a hydrogen gas electrochemically reacts with an oxidizing agent to generate electrical energy. The stack is described referring to FIG. 2.

FIG. 2 is an exploded perspective view of a fuel cell stack according to one embodiment.

Referring to FIG. 2, the stack 130 includes a plurality of unit cell 131 where an oxidation/reduction reaction of a hydrogen gas and an oxidizing agent occurs to generate electrical energy.

Each unit cell 131 refers to a unit cell to generate electricity, and includes a membrane-electrode assembly 132 where hydrogen gas and oxygen of an oxidizing agent are oxidized/reduced, and a separator (or a bipolar plate) 133 to supply hydrogen gas and an oxidizing agent to the membrane-electrode assembly 132. The membrane-electrode assembly 132 is the same as described above. The separators 133 are arranged on both side of the membrane-electrode assembly 132. Herein, the separators that are respectively located at the most exterior sides of the stack are referred to as, particularly, end plates.

Hereinafter, the following examples illustrate the embodiments in more detail. However, it is understood that the disclosure is not limited by these examples.

### Preparation of Catalyst Layer for Fuel Cell

### Example 1

A first catalyst (TEC36F52, Tanaka Inc., Hiratsuka, Kanagawa, Japan) was prepared by supporting 52 wt % of a Pt₃Co alloy with 48 wt % of carbon.

A second catalyst in which 77 wt % of the IrRuOₓ (0.5≦x≦2) and 2 wt % of the SiO₂ were supported with 21 wt % of carbon was prepared by mixing hexachloroiridic acid (H₂IrCl₆) and ruthenium chloride (RuCl₃) in an atomic ratio of 1:1 between Ir and Ru, adding 75 wt % of SiO₂ to 20 wt % of the resulting mixture, supporting the obtained mixture with 5 wt % of stabilized carbon which was produced by heat-treating ketjen black at 2250° C., primarily heat-treating the resultant mixture at 300° C. under a hydrogen atmosphere, secondarily heat-treating it at 250° C. under an air atmosphere, and removing a part of the SiO₂ through NaOH.

92.6 wt % of the first catalyst was mixed with 7.4 wt % of the second catalyst to prepare a catalyst mixture and 67 wt % of the catalyst mixture was mixed with 33 wt % of Nafion® (DuPont Co., Ltd., Wilmington, Del., United States), preparing a composition for a catalyst layer. Herein, the IrRuOₓ (0.5≦x≦2) was included in an amount of 5 parts by weight based on 100 parts by weight of the first catalyst.

### Example 2

A first catalyst (TEC36F52, Tanaka Inc., Hiratsuka, Kanagawa, Japan) was prepared by supporting 52 wt % of a Pt₃Co alloy with 48 wt % of carbon.

A second catalyst in which 77 wt % of the IrRuOₓ (0.5≦x≦2) and 2 wt % of the SiO₂ were supported with 21 wt % of the carbon was prepared by mixing chloroiridic acid (H₂IrCl₆) and ruthenium chloride (RuCl₃) in an atomic ratio of 1:1 between Ir and Ru, adding 75 wt % of SiO₂ to 20 wt % of the mixture, supporting the obtained mixture with 5 wt % of a stabilized carbon stabilized which was prepared by heat-treating ketjen black at 2250° C., primarily heat-treating the resultant mixture at 300° C. under a hydrogen atmosphere, secondarily heat-treating it at 250° C. under an air atmosphere, and removing a part of the SiO₂ through NaOH.

89.4 wt % of the first catalyst was mixed with 10.6 wt % of the second catalyst, and 67.4 wt % of the mixed catalyst was mixed with 32.6 wt % of Nafion (DuPont Co., Ltd., Wilmington, Del., United States), preparing a composition for a catalyst layer.

Herein, the IrRuOₓ (0.5≦x≦2) was included in an amount of 7.5 parts by weight based on 100 parts by weight of the first catalyst.

### Example 3

A first catalyst was prepared by supporting 46 wt % of Pt with 54 wt % of a stabilized carbon obtained by heat-treating ketjen black at 2250° C. (Pt50/S2J3D, RTX; Daejon, Republic of Korea).

A second catalyst in which 77 wt % of the IrRuOₓ (0.5≦x≦2) and 2 wt % of the SiO₂ were supported with 21 wt % of the stabilized carbon was prepared by mixing chloroiridic acid (H₂IrCl₆) and ruthenium chloride (RuCl₃) in an atomic ratio of 1:1 between Ir and Ru, adding 75 wt % of SiO₂ to 20 wt % of the mixture, supporting the obtained mixture with 5 wt % of a stabilized carbon which was produced by heat-treating ketjen black at 2250° C., primarily heat-treating the resultant mixture at 300° C. under a hydrogen atmosphere, secondarily heat-treating it at 250° C. under an air atmosphere, and removing a part of the SiO₂ through NaOH.

96.2 wt % of the first catalyst was mixed with 3.8 wt % of the second catalyst, and 77.5 wt % of the mixed catalyst was mixed with 22.5 wt % of Nafion (DuPont Co., Ltd., Wilmington, Del., United States), preparing a composition for a catalyst layer. Herein, the IrRuOₓ (0.5≦x≦2) was included in an amount of 2.5 parts by weight based on 100 parts by weight of the first catalyst.

### Example 4

A second catalyst in which 42 wt % of the IrRuOₓ (0.5≦x≦2) and 2 wt % of the SiO₂ were supported with 56 wt % of the stabilized carbon was prepared by mixing chloroiridic acid (H₂IrCl₆) and ruthenium chloride (RuCl₃) in an atomic ratio of 1:1 between Ir and Ru, adding 55.6 wt % of SiO₂ to 20 wt % of the mixture, supporting the obtained mixture with 24.4 wt % of a stabilized carbon which was produced by heat-treating ketjen black at 2250° C., primarily heat-treating the resultant mixture at 300° C. under a hydrogen atmosphere, secondarily heat-treating it at 250° C. under an air atmosphere, and removing a part of the SiO₂ through NaOH.

A composition for a catalyst layer was prepared according to the same method as Example 1 except for using the above second catalyst instead of the second catalyst of Example 1.

### Example 5

A second catalyst in which 42 wt % of IrRuOₓ (0.5≦x≦2) and 2 wt % of SiO₂ were supported with 56 wt % of stabilized carbon was prepared by mixing chloroiridic acid (H₂IrCl₆) and ruthenium chloride (RuCl₃) in an atomic ratio of 1:2 between Ir and Ru, adding 55.6 wt % of the SiO₂ to 20 wt % of the mixture, supporting the obtained mixture with 24.4 wt % of a stabilized carbon which was produced by heat-treating ketjen black at 2250° C., primarily heat-treating the resultant mixture at 300° C. under a hydrogen atmosphere, secondarily heat-treating it at 250° C. under an air atmosphere, and removing a part of the SiO₂ through NaOH.

A catalyst layer composition was prepared according to the same method as Example 1 except for using the above second catalyst instead of the second catalyst of Example 1.

### Example 6

A second catalyst in which 42 wt % of IrRuOₓ (0.5≦x≦2) and 2 wt % of SiO₂ were supported with 56 wt % of stabilized carbon was prepared by mixing chloroiridic acid (H₂IrCl₆) and ruthenium chloride (RuCl₃) in an atomic ratio of 2:1 between Ir and Ru, adding 55.6 wt % of the SiO₂ to 20 wt % of the mixture, supporting the obtained mixture with 24.4 wt % of a stabilized carbon which was produced by heat-treating ketjen black at 2250° C., primarily heat-treating the resultant mixture at 300° C. under a hydrogen atmosphere, secondarily heat-treating it at 250° C. under an air atmosphere, and removing a part of the SiO₂ through NaOH.

A catalyst layer composition was prepared according to the same method as Example 1 except for using the above second catalyst instead of the second catalyst of Example 1.

### Example 7

A first catalyst (TEC36F52, Tanaka Inc., Hiratsuka, Kanagawa, Japan) in which 52 wt % of a Pt₃Co alloy was supported with 48 wt % of carbon was prepared.

A second catalyst in which 24 wt % of IrRuOₓ (0.5≦x≦2) and 2 wt % of SiO₂ were supported with 74 wt % of stabilized carbon was prepared by mixing chloroiridic acid (H₂IrCl₆) and ruthenium chloride (RuCl₃) in an atomic ratio of 1:1 between Ir and Ru, adding 20 wt % of SiO₂ to 20 wt % of the mixture, supporting the obtained mixture with 60 wt % of a stabilized carbon which was produced by heat-treating ketjen black at 2250° C., primarily heat-treating the resultant mixture at 300° C. under a hydrogen atmosphere, secondarily heat-treating it at 250° C. under an air atmosphere, and removing a part of the SiO₂ through NaOH.

96.2 wt % of the first catalyst was mixed with 3.8 wt % of the second catalyst, and 33.4 wt % of Nafion (DuPont Co., Ltd., Wilmington, Del., United States) was added to 66.6 wt % of the mixed catalyst, preparing a composition for a catalyst layer. Herein, the IrRuOₓ (0.5≦x≦2) was included in an amount of 2.5 parts by weight based on 100 parts by weight of the first catalyst.

### Example 8

A second catalyst in which 42 wt % of IrRuOₓ (0.5≦x≦2) and 2 wt % of SiO₂ were supported by 56 wt % of stabilized carbon was prepared by mixing chloroiridic acid (H₂IrCl₆) and ruthenium chloride (RuCl₃) in an atomic ratio of 1:1 between Ir and Ru, adding 55.6 wt % of the SiO₂ to 20 wt % of the obtained mixture, supporting the resultant with 24.4 wt % of a stabilized carbon which was produced by heat-treating ketjen black at 2250° C., primarily heat-treating the resultant mixture at 300° C. under a hydrogen atmosphere, secondarily heat-treating it at 250° C. under an air atmosphere, and removing a part of the SiO₂ through NaOH.

A composition for a catalyst layer was prepared according to the same method as Example 7 except for using the above second catalyst instead of the second catalyst of Example 7.

### Example 9

A second catalyst in which 68 wt % of IrRuOₓ (0.5≦x≦2) and 2 wt % of SiO₂ were supported with 30 wt % of stabilized carbon was prepared by mixing chloroiridic acid (H₂IrCl₆) and ruthenium chloride (RuCl₃) in an atomic ratio of 1:1 between Ir and Ru, adding 71.4 wt % of the SiO₂ to 20 wt % of the mixture, supporting the obtained mixture with 8.6 wt % of a stabilized carbon which was produced by heat-treating ketjen black at 2250° C., primarily heat-treating the resultant mixture at 300° C. under a hydrogen atmosphere, secondarily heat-treating it at 250° C. under an air atmosphere, and removing a part of SiO₂ through NaOH.

A composition for a catalyst layer Example 7 was prepared according to Example 7 except for using the above second catalyst instead of the second catalyst of Example 7.

### Example 10

A second catalyst in which 77 wt % of IrRuOₓ (0.5≦x≦2) and 2 wt % of SiO₂ were supported with 21 wt % of stabilized carbon was prepared by mixing chloroiridic acid (H₂IrCl₆) and ruthenium chloride (RuCl₃) in an atomic ratio of 1:1 between Ir and Ru, adding 75 wt % of SiO₂ to 20 wt % of the mixture, supporting the obtained mixture with 5 wt % of a stabilized carbon which was produced by heat-treating ketjen black at 2250° C., primarily heat-treating the resultant mixture at 300° C. under a hydrogen atmosphere, secondarily heat-treating it at 250° C. under an air atmosphere, and removing a part of the SiO₂ through NaOH.

A composition for a catalyst layer was prepared according to the same method as Example 7 except for using the above second catalyst instead of the second catalyst of Example 7.

### Example 11

A second catalyst in which 95 wt % of IrRuOₓ (0.5≦x≦2) and 2 wt % of SiO₂ were supported with 3 wt % of stabilized carbon were prepared by mixing chloroiridic acid (H₂IrCl₆) and ruthenium chloride (RuCl₃) in an atomic ratio of 1:1 between Ir and Ru, adding 79.4 wt % of the SiO₂ to 20 wt % of the mixture, supporting the obtained mixture with 0.6 wt % of a stabilized carbon by heat-treating ketjen black at 2250° C., primarily heat-treating the resultant mixture at 300° C. under a hydrogen atmosphere, secondarily heat-treating it at 250° C. under an air atmosphere and removing a part of the SiO₂ through NaOH.

A composition for a catalyst layer was prepared according to the same method as Example 7 except for using the above second catalyst instead of the second catalyst of Example 7.

### Example 12

A first catalyst (TEC36F52, Tanaka Inc., Hiratsuka, Kanagawa, Japan) in which 52 wt % of a Pt₃Co alloy was supported with 48 wt % of carbon was prepared.

A second catalyst in which 24 wt % of IrRuOₓ (0.5≦x≦2) and 2 wt % of SiO₂ were supported with 74 wt % of stabilized carbon were prepared by mixing chloroiridic acid (H₂IrCl₆) and ruthenium chloride (RuCl₃) in an atomic ratio of 1:1 between Ir and Ru, adding 20 wt % of the SiO₂ to 20 wt % of the mixture, supporting the obtained mixture with 60 wt % of a stabilized carbon which was produced by heat-treating ketjen black at 2250° C., primarily heat-treating the resultant mixture at 300° C. under a hydrogen atmosphere, secondarily heat-treating it at 250° C. under an air atmosphere and removing a part of the SiO₂ through NaOH.

A composition catalyst layer was prepared by mixing 98.4 wt % of the first catalyst and 1.6 wt % of the second catalyst and adding 33.7 wt % of Nafion (DuPont Co., Ltd., Wilmington, Del., United States) to 66.3 wt % of the mixed catalyst. Herein, the IrRuOₓ (0.5≦x≦2) was used in an amount of

1 part by weight based on 100 parts by weight of the first catalyst.

### Example 13

A second catalyst in which 42 wt % of IrRuOₓ (0.5≦x≦2) and 2 wt % of SiO₂ were supported with 56 wt % of stabilized carbon were prepared by mixing chloroiridic acid (H₂IrCl₆) and ruthenium chloride (RuCl₃) in an atomic ratio of 1:1 between Ir and Ru, adding 55.6 wt % of the SiO₂ to 20 wt % of the mixture, supporting the obtained mixture with 24.4 wt % of carbon stabilized by heat-treating ketjen black at 2250° C., primarily heat-treating the resultant mixture at 300° C. under a hydrogen atmosphere, secondarily heat-treating it at 250° C. under an air atmosphere and removing a part of the SiO₂ through NaOH.

A composition for a catalyst layer was prepared according to the same method as Example 12 except for using the above second catalyst instead of the second catalyst of Example 12.

### Example 14

A second catalyst in which 68 wt % of IrRuOₓ (0.5≦x≦2) and 2 wt % of SiO₂ were supported with 30 wt % of stabilized carbon were prepared by mixing chloroiridic acid (H₂IrCl₆) and ruthenium chloride (RuCl₃) in an atomic ratio of 1:1 between Ir and Ru, adding 71.4 wt % of the SiO₂ to 20 wt % of the mixture, supporting the obtained mixture with 8.6 wt % of carbon stabilized by heat-treating ketjen black at 2250° C., primarily heat-treating the resultant mixture at 300° C. under a hydrogen atmosphere, secondarily heat-treating it at 250° C. under an air atmosphere and removing a part of the SiO₂ through NaOH.

A composition for a catalyst layer was prepared according to the same method as Example 12 except for using the above second catalyst instead of the second catalyst of Example 12.

### Example 15

A second catalyst in which 77 wt % of IrRuOₓ (0.5≦x≦2) and 2 wt % of SiO₂ were supported with 21 wt % of stabilized carbon were prepared by mixing chloroiridic acid (H₂IrCl₆) and ruthenium chloride (RuCl₃) in an atomic ratio of 1:1 between Ir and Ru, adding 75 wt % of the SiO₂ to 20 wt % of the mixture, supporting the obtained mixture with

5 wt % of carbon stabilized by heat-treating ketjen black at 2250° C., primarily heat-treating the resultant mixture at 300° C. under a hydrogen atmosphere, secondarily heat-treating it at

250° C. under an air atmosphere and removing a part of the SiO₂ through NaOH.

A composition for a catalyst layer was prepared according to the same method as Example 12 except for using the above second catalyst instead of the second catalyst of Example 12.

### Example 16

A second catalyst in which 95 wt % of IrRuOₓ (0.5≦x≦2) and 2 wt % of SiO₂ were supported with 3 wt % of stabilized carbon were prepared by mixing chloroiridic acid (H₂IrCl₆) and ruthenium chloride (RuCl₃) in an atomic ratio of 1:1 between Ir and Ru, adding 79.4 wt % of the SiO₂ to 20 wt % of the mixture, supporting the obtained mixture with 0.6 wt % of carbon stabilized by heat-treating ketjen black at 2250° C., primarily heat-treating the resultant mixture at 300° C. under a hydrogen atmosphere, secondarily heat-treating it at 250° C. under an air atmosphere and removing a part of the SiO₂ through NaOH.

A composition for a catalyst layer was prepared according to the same method as Example 12 except for using the above second catalyst instead of the second catalyst of Example 12.

### Comparative Example 1

A composition for a catalyst layer was prepared according to the same method as Example 1 except for using no second catalyst of Example 1.

### Comparative Example 2

A composition for a catalyst layer was prepared according to the same method as Example 3 except for using no second catalyst of Example 3.

### Comparative Example 3

A second catalyst in which 42 wt % of IrO_{y} (0.5≦x≦2) and 2 wt % of SiO₂ were supported with 56 wt % of stabilized carbon were prepared by adding 20 wt % of chloroiridic acid (H₂IrCl₆) to 55.6 wt % of the SiO₂, supporting the mixture with 24.4 wt % of stabilized carbon which was produced by heat-treating ketjen black at 2250° C., primarily heat-treating the resultant mixture at 300° C. under a hydrogen atmosphere, secondarily heat-treating it at 250° C. under an air atmosphere and removing a part of the SiO₂ through NaOH.

A composition for a catalyst layer was prepared according to the same method as Example 1 except for using the above second catalyst instead of the second catalyst of Example 1.

### Comparative Example 4

A second catalyst in which 42 wt % of IrRu₄Oₓ (0.5≦x≦2) and 2 wt % of SiO₂ were supported with 56 wt % of stabilized carbon were prepared by mixing chloroiridic acid (H₂IrCl₆) and ruthenium chloride (RuCl₃) in an atomic ratio of 1:4 between Ir and Ru, adding 55.6 wt % of the SiO₂ to 20 wt % of the mixture, supporting the mixture with 24.4 wt % of carbon stabilized by heat-treating ketjen black at 2250° C., primarily heat-treating the resultant mixture at 300° C. under a hydrogen atmosphere, secondarily heat-treating it at 250° C. under an air atmosphere and removing a part of the SiO₂ through NaOH.

A composition for a catalyst layer was prepared according to the same method as Example 1 except for using the above second catalyst instead of the second catalyst of Example 1.

### Comparative Example 5

A second catalyst in which 42 wt % of IrRu₄Oₓ (0.5≦x≦2) and 2 wt % of SiO₂ were supported with 56 wt % of stabilized carbon were prepared by mixing chloroiridic acid (H₂IrCl₆) and ruthenium chloride (RuCl₃) in an atomic ratio of 4:1 between Ir and Ru, adding 55.6 wt % of the SiO₂ to 20 wt % of the mixture, supporting the mixture with 24.4 wt % of carbon stabilized by heat-treating ketjen black at 2250° C., primarily heat-treating the resultant mixture at 300° C. under a hydrogen atmosphere, secondarily heat-treating it at 250° C. under an air atmosphere and removing a part of the SiO₂ through NaOH.

A composition for a catalyst layer was prepared according to the same method as Example 1 except for using the above second catalyst instead of the second catalyst of Example 1.

### Comparative Example 6

A composition for a catalyst layer was prepared according to the same method as Example 1 except for preparing the second catalyst without adding SiO₂ thereto.

The catalyst compositions according to Examples 1 to 16 and Comparative Examples 1 to 6 were provided in the following Table 1.

TABLE 1

| | | Second catalyst | | Weight ratio | |
|---|---|---|---|---|---|
| | | atomic | | of first | IrRuOₓ |
| | | ratio | weight ratio | catalyst:sec- | (parts by |
| | | Ir:Ru | IrRuOₓ:SiO₂:C | ond catalyst | weight*) |
| Examples | 1 | 1:1 | 77:2:21 | 92.6:7.4 | 5 |
| | 2 | 1:1 | 77:2:21 | 89.4:10.6 | 7.5 |
| | 3 | 1:1 | 77:2:21 | 96.2:3.8 | 2.5 |
| | 4 | 1:1 | 42:2:56 | 92.6:7.4 | 5 |
| | 5 | 1:2 | 42:2:56 | 92.6:7.4 | 5 |
| | 6 | 2:1 | 42:2:56 | 92.6:7.4 | 5 |
| | 7 | 1:1 | 24:2:74 | 96.2:3.8 | 2.5 |
| | 8 | 1:1 | 42:2:56 | 96.2:3.8 | 2.5 |
| | 9 | 1:1 | 68:2:30 | 96.2:3.8 | 2.5 |
| | 10 | 1:1 | 77:2:21 | 96.2:3.8 | 2.5 |
| | 11 | 1:1 | 95:2:3 | 96.2:3.8 | 2.5 |
| | 12 | 1:1 | 24:2:74 | 98.4:1.6 | 1 |
| | 13 | 1:1 | 42:2:56 | 98.4:1.6 | 1 |
| | 14 | 1:1 | 68:2:30 | 98.4:1.6 | 1 |
| | 15 | 1:1 | 77:2:21 | 98.4:1.6 | 1 |
| | 16 | 1:1 | 95:2:3 | 98.4:1.6 | 1 |
| Comparative | 1 | — | — | 100:0 | — |
| Examples | 2 | — | — | 100:0 | — |
| | 3 | — | IrO_{y}:SiO₂:C | | |
| | | | 42:2:56 | | |
| | 4 | 1:4 | 42:2:56 | 92.6:7.4 | 5 |
| | 5 | 4:1 | 42:2:56 | 92.6:7.4 | 5 |
| | 6 | 1:1 | 79:0:21 | 92.6:7.4 | 5 |

In the Table 1, “parts by weight*” indicates the amount of IrRuOₓ based on 100 parts by weight of the first catalyst. (Manufacture of Membrane-Electrode Assembly for Fuel Cell)

Each composition for a catalyst layer according to Examples 1 to 16 and Comparative Examples 1 to 6 was coated on a FEP (fluorinated ethylene propylene) film and sufficiently dried at 90° C. in a convection oven for 5 hours to form a catalyst layer, and the catalyst layer may be used as a cathode catalyst layer consisting of a cathode and an anode catalyst layer consisting of an anode.

The cathode and anode catalyst layers were transferred to a fluorine-based membrane, and the FEP film was removed, manufacturing a membrane-catalyst layer assembly. The membrane-catalyst layer assembly and a 35BC diffuse layer made by SGL Co., SohnleinstraBe 8 65201 Wiesbaden Germany, manufacturing a membrane-electrode assembly.

### Evaluation 1

As for the membrane-electrode assembly, initial performance was measured at 65° C. by providing each cathode with O₂ of relative humidity of 100% and each anode with H₂ of relative humidity of 100%.

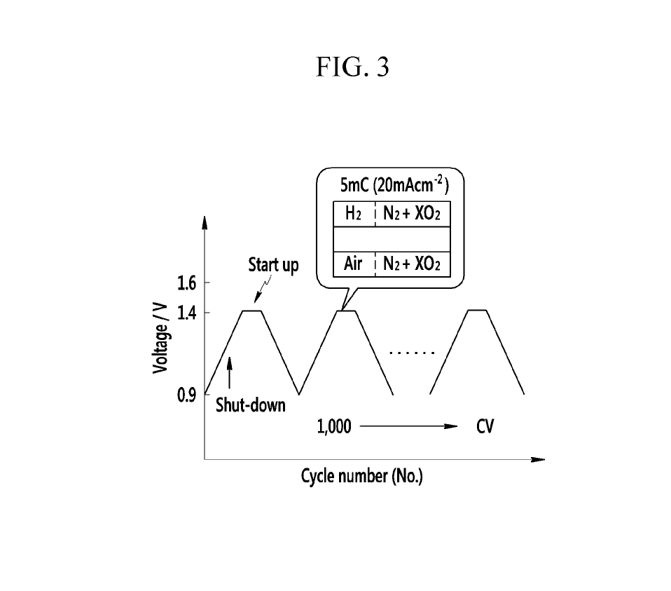

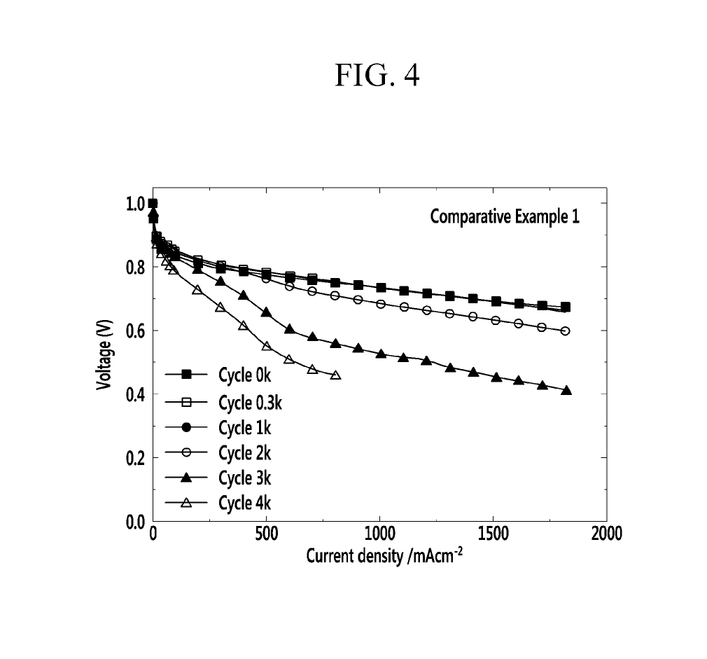

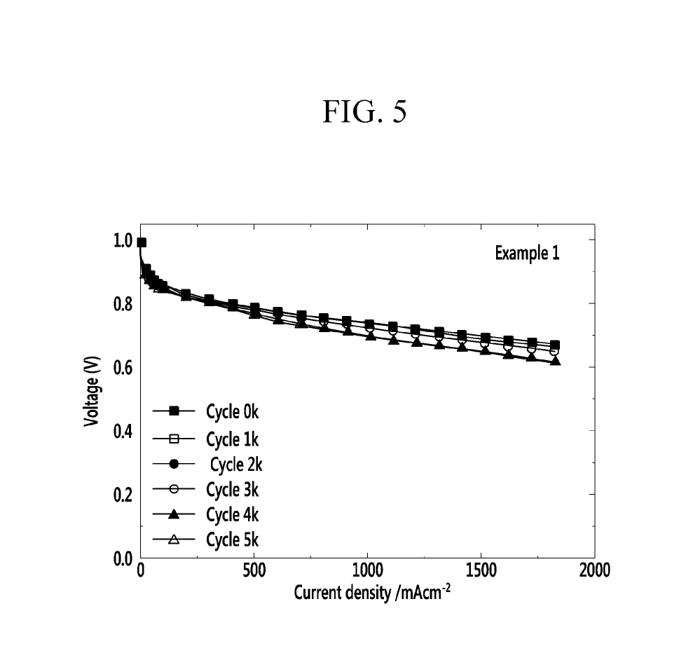

A start-up/shut-down repetition experiment was performed by providing each cathode with N₂ gas of relative humidity of 100% and each anode with H₂ of relative humidity of 100%, measuring a current-voltage performance by every 1,000 times (in drawings, 1,000 times is denoted as “k”) in a method provided in FIG. 3, and electrochemically analyzing the measurements. The start-up/shut-down cycle results are provided in FIGS. 4 and 5.

FIG. 3 is a graph showing the electrochemical phenomenon generated by a car using a fuel cell during the start-up/shut-down cycle. Furthermore, FIG. 4 is graph showing the current density of the membrane-electrode assembly of Comparative Example 1 and FIG. 5 is a graph showing the current density of the membrane-electrode assembly of Example 1 as a start-up/shut-down cycle goes. In FIGS. 4 and 5, k indicates 1,000 times, as illustrated above, e.g., Cycle 0.3 k indicates 300 cycles.

Referring to FIGS. 4 and 5, Example 1 using the reaction-induced material according to an embodiment as a catalyst for a fuel cell showed excellent battery durability performance before and after the start-up/shut-down repetition experiment compared with Comparative Example 1.

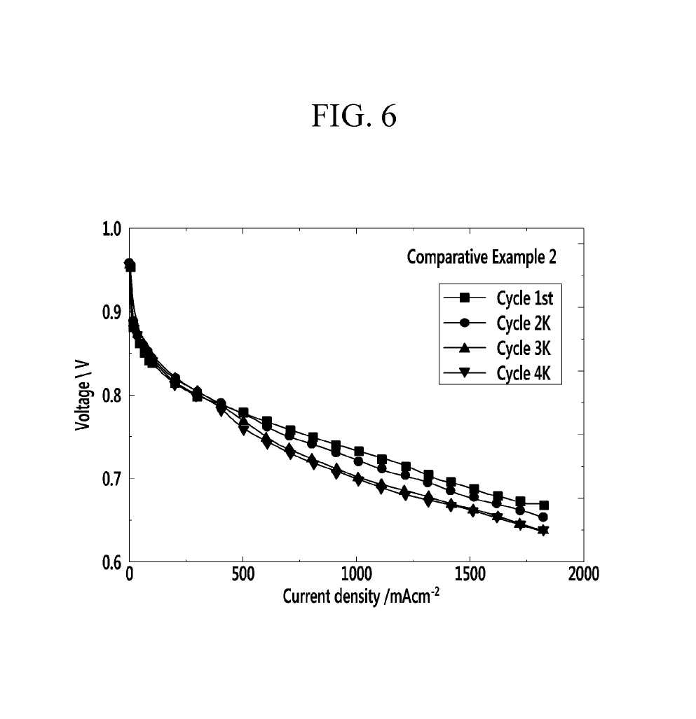

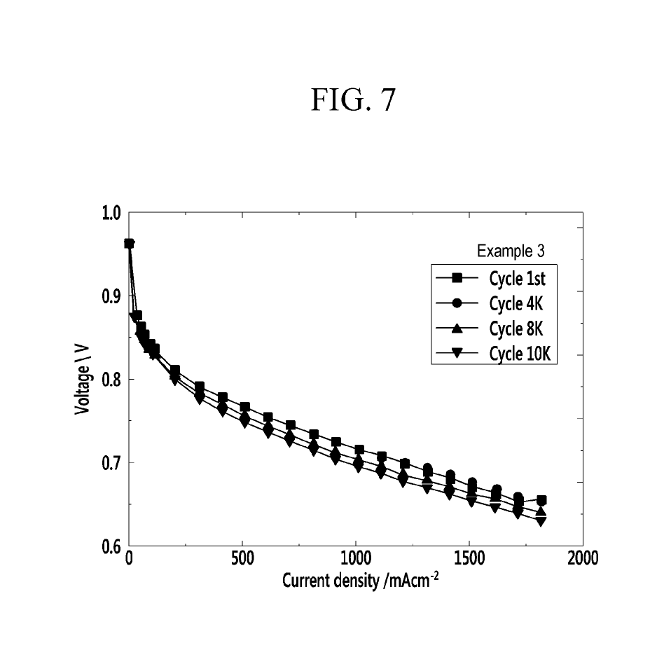

FIG. 6 shows current density of membrane-electrode assembly of Comparative Example 2 depending on a start-up/shut-down cycle, and FIG. 7 shows current density of membrane-electrode assembly of Example 3 depending on a start-up/shut-down cycle.

Referring to FIGS. 6 and 7, Example 3 using the reaction-induced material according to an embodiment as a catalyst for a fuel cell showed excellent battery durability performance before and after the start-up/shut-down repetition experiment compared with Comparative Example 2. In addition, durability performance of a battery cell turned out to be stabilized by a reaction-induced material even though a carbon carrier obtained by heat-treating carbon at a high temperature to increase crystallinity was used.

### Evaluation 2

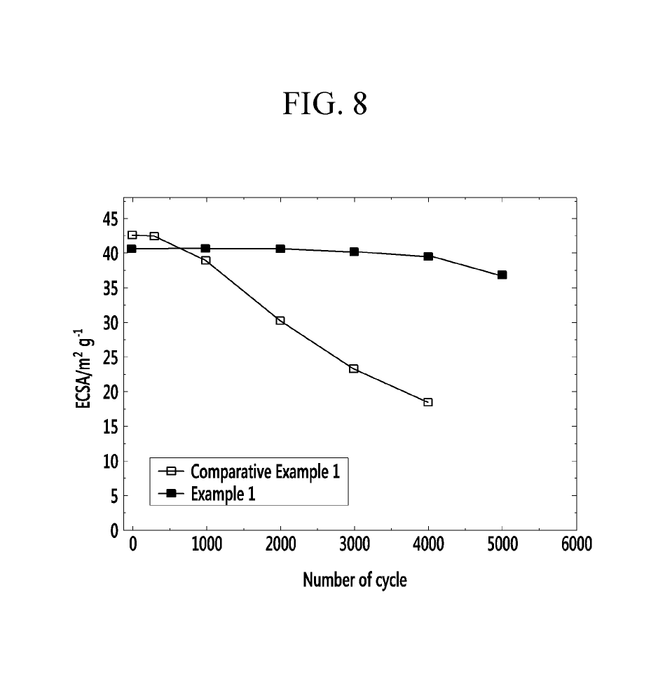

Electrochemical surface area (ECSA) of each catalyst layer according to Example 1 and Comparative Example 1 depending on a cycle was evaluated, and the results are provided in FIG. 8.

FIG. 8 is a graph showing electrochemical surface area (ECSA) changes of the catalyst layers according to Example 1 and Comparative Example 1 depending on a start-up/shut-down cycle.

Referring to FIG. 8, when measured at 1,000 mA/cm² and 4000 cycles, Example 1 showed a voltage loss of −9 mV, while Comparative Example 1 showed a voltage loss of greater than −300 mV, and thus, Example 1 showed an electrochemical surface area loss rate of 15%, while Comparative Example 1 showed an electrochemical surface area loss rate of 57%. Accordingly, Example 1 using the reaction-induced material according to one embodiment as a catalyst for a fuel cell prevented carbon carrier degradation of the catalyst during the start-up/shut-down cycle experiment and thus, maintained high fuel cell performance compared with Comparative Example 1.

In addition, the electrochemical surface area (ECSA) evaluation results of the catalyst layers according to Examples 1 to 3 and Comparative Example 1 and 2 at 4,000 cycles is provided in the following Table 2.

TABLE 2

| | Voltage loss at | ECSA |
|---|---|---|
| | 1000 mA/cm² (mV) | loss (%) |
| Comparative | >−300 | 57 |
| Example 1 | | |
| Example 1 | −9 | 15 |
| Example 2 | −9 | 13 |
| Comparative | −34 | 24 |
| Example 2 | | |
| Example 3 | 0 | 1 |

Referring to the Table 2, Examples 1 to 3 using the reaction-induced material according to one embodiment as a catalyst for a fuel cell showed high catalyst durability and thus, maintain high fuel cell durability performance compared with Comparative Examples 1 and 2.

### Evaluation 3

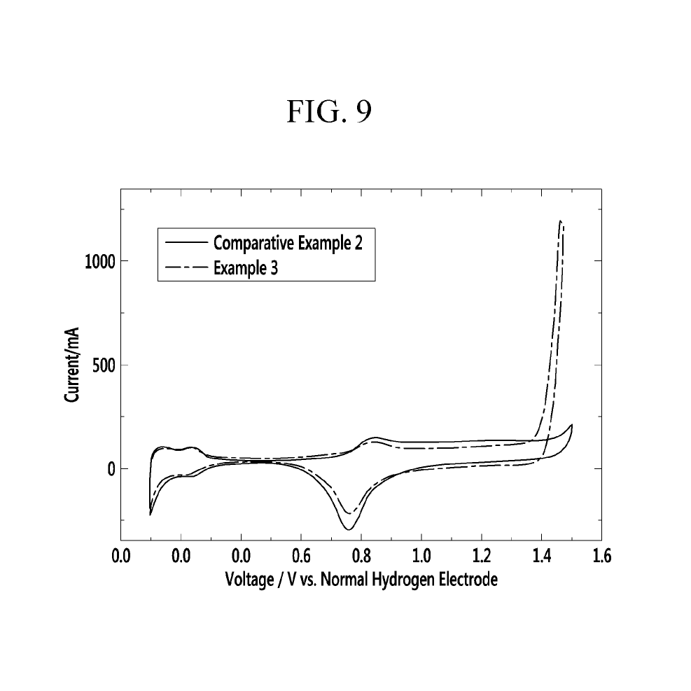

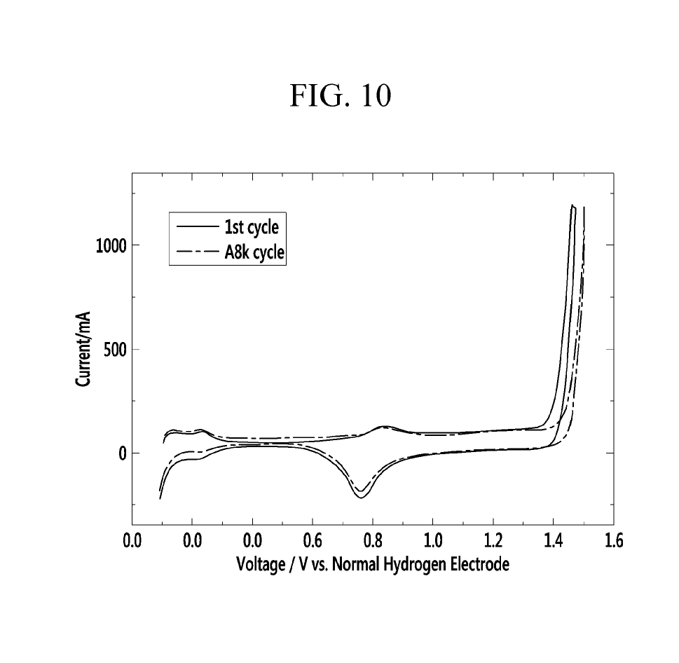

Oxygen evolution reaction (OER) activity of the catalyst layers according to Comparative Example 2 and Example 3 was evaluated by maintaining a unit battery cell at 65° C., providing a cathode with N₂ of relative humidity of 100% and an anode with H₂ of relative humidity of 100% in cyclic voltammetry (CV) method. The scan range of a voltage was expanded up to 0 V to 1.5 V, in which water was decomposed. The results are provided in FIGS. 9 and 10.

FIG. 9 is a graph showing cyclic voltage-currents of the catalyst layers according to Comparative Example 2 and Example 3, and FIG. 10 is a graph showing cyclic voltage-current of the Example 3 depending on a start-up/shut-down cycle.

Referring to FIG. 9, Example 3 showed sharply increasing current around 1.4 V. Accordingly, an oxygen evolution reaction occurred in which water was decomposed and generated oxygen was generated. Therefore, when the reaction-induced material according to one embodiment was used as a catalyst for a fuel cell, water was decomposed before carbon was corroded and thus, increased stability of the fuel cell catalyst. In addition, referring to FIG. 10, Example 3 maintained high activity of the water-decomposition catalyst even at 8,000 cycles of start-up/shut-down.

### Evaluation 4

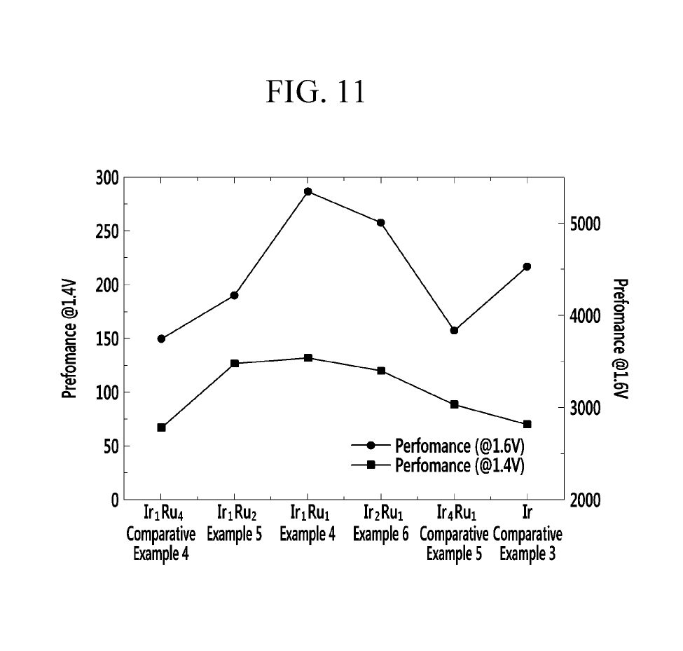

In order to evaluate activity of the catalyst layers according to Examples 4 to 6 and Comparative Examples 3 to 5, their currents measured in the method of Evaluation 3 in a range of 1.4 V and 1.6 V was provided in FIG. 11.

FIG. 11 is a graph showing water decomposition performances of the catalyst layers according to Examples 4 to 6 and Comparative Examples 3 to 5 in a range of 1.4 V and 1.6 V.

Referring to FIG. 11, Examples 4 to 6 using a reaction-induced material of an oxide having an Ir/Ru atomic ratio ranging from 0.5 to 2 as a catalyst showed excellent water decomposition performance (activity, stability) in both 1.4 V and 1.6 V compared with Comparative Examples 3 to 5 using a reaction-induced material having an Ir/Ru atomic ratio out of the range.

### Evaluation 5

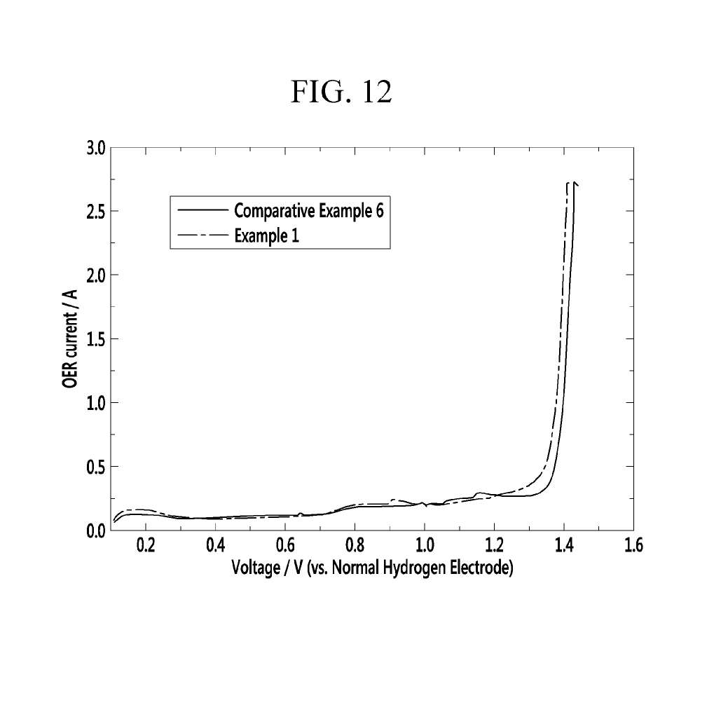

Activity of each catalyst layer according to Example 1 and Comparative Example 6 was evaluated by performing a measurement in the same method as Evaluation 3, and the results are provided in FIG. 12.

FIG. 12 provides the voltage-current graph of the catalyst layers according to Example 1 and Comparative Example 6.

Referring to FIG. 12, Example 1 using a reaction-induced material including SiO₂ as a catalyst for a fuel cell had an on-set potential at a lower voltage than Comparative Example 6 using a reaction-induced material including no SiO₂. In other words, Example 1 showed an on-set potential at 1.21 V, while Comparative Example 6 showed an on-set potential at 1.32 V. Accordingly, the SiO₂ played a role of an initiator in an oxygen evolution reaction and thus, much increased use of the catalyst.

### Evaluation 6

Activity of each catalyst layer according to Comparative Example 1 and Examples 7 to 16 was evaluated by performing a measurement in the same method as Evaluations 1 and 2, and the results are provided in the following Table 3.

TABLE 3

| | Reaction-induced | | | | Voltage loss |
|---|---|---|---|---|---|
| | material composition | | | IrRuOx | at 1000 |
| | Oxide | SiO₂ | Carrier | (parts by | mA/cm² |
| | (wt %) | (wt %) | (wt %) | weight)* | (mV) |
| Comparative | 0 | 0 | 0 | 0 | −300 |
| Example 1 | | | | | |
| Example 7 | 24 | 2 | 74 | 2.5 | −58 |
| Example 8 | 42 | 2 | 56 | 2.5 | −28 |
| Example 9 | 68 | 2 | 30 | 2.5 | −11 |
| Example 10 | 77 | 2 | 21 | 2.5 | −9 |
| Example 11 | 95 | 2 | 3 | 2.5 | −30 |
| Example 12 | 24 | 2 | 74 | 1 | −60 |
| Example 13 | 42 | 2 | 56 | 1 | −30 |
| Example 14 | 68 | 2 | 30 | 1 | −15 |
| Example 15 | 77 | 2 | 21 | 1 | −14 |
| Example 16 | 95 | 2 | 0 | 1 | −40 |

In the Table 3, “parts by weight*” indicates the amount of IrRuOx based on 100 parts by weight of a first catalyst.

Referring to the Table 3, Examples 7 to 11 and 12 to 16 using the reaction-induced material according to one embodiment as a catalyst for a fuel cell showed higher water decomposition activity than Comparative Example 1 and thus, stably played a role of protecting a main catalyst and maintained high fuel cell performance after the start-up/shut-down cycles.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A catalyst for a fuel cell, comprising
an oxide represented by the following Chemical Formula 1;
a reaction-induced material including SiO₂.
IrₐRu_{b}Oₓ [Chemical Formula 1]
wherein,
a/b ratio ranges from about 0.3 to about 3.5, and
x is an integer of about 0.5 to about 2.

2. The catalyst for a fuel cell of claim 1, wherein in the oxide represented by the Chemical Formula 1, the a/b ratio ranges from about 0.5 to about 2.

3. The catalyst for a fuel cell of claim 1, wherein the oxide represented by the Chemical Formula 1 has a shape of a nanoparticle, a nanorod, a core-shell or a combination thereof.

4. The catalyst for a fuel cell of claim 1, wherein the oxide has an average particle diameter (D50) of about 1 nm to about 6 nm.

5. The catalyst for a fuel cell of claim 1, further comprising a carrier supporting the oxide represented by the Chemical Formula 1.

6. The catalyst for a fuel cell of claim 5, wherein the carrier comprises graphite, denka black, ketjen black, acetylene black, carbon nanotube, carbon nano fibers, a carbon nano wires, a carbon nano balls, activated carbon, stabilized carbon, indium tin oxide (ITO), TiO₂, WO, SiO₂, or a combination thereof.

7. The catalyst for a fuel cell of claim 5, wherein the SiO₂ is included in an amount of about 0.5 wt % to about 5 wt % based on the total amount of the oxide represented by the Chemical Formula 1 and the carrier.

8. The catalyst for a fuel cell of claim 5, wherein the sum of the oxide represented by the Chemical Formula 1 and the SiO₂ is included in an amount of about 20 wt % to about 99 wt % based on the total amount of the oxide, the SiO₂ and the carrier.

9. The catalyst for a fuel cell of claim 1, which further comprises an active material comprising a metal.

10. The catalyst for a fuel cell of claim 9, wherein the active material further comprises a carrier supporting the metal.

11. The catalyst for a fuel cell of claim 10, wherein the metal is included in an amount of about 10 wt % to about 80 wt % based on the total amount of the metal and the carrier.

12. The catalyst for a fuel cell of claim 9, wherein the oxide represented by the Chemical Formula 1 is included in an amount of about 0.5 parts by weight to about 10 parts by weight based on 100 parts by weight of the active material.

13. A method of preparing a catalyst for a fuel cell, comprising
mixing an iridium precursor and a ruthenium precursor so that an Ir/Ru atomic ratio is about 0.3 to about 3.5 and adding SiO₂ thereto to obtain a mixture;
subjecting the mixture to a first heat treatment;
subjecting the first heat-treated mixture to a second heat treatment; and
removing at least one part of the SiO₂ from the second heat treated mixture to prepare an oxide represented by the following Chemical Formula 1, and a reaction-induced material comprising SiO₂.
IrₐRu_{b}Oₓ [Chemical Formula 1]
wherein, a/b ratio ranges from about 0.3 to about 3.5, and x is an integer of about 0.5 to about 2.

14. The method of claim 13, wherein a carrier is further added to the mixture.

15. The method of claim 14, wherein the carrier comprises graphite, denka black, ketjen black, acetylene black, carbon nanotube, carbon nano fibers, carbon nano wires, carbon nano balls, activated carbon, stabilized carbon, indium tin oxide (ITO), TiO₂, WO, SiO₂, or a combination thereof.

16. The method of claim 13, wherein the first heat treatment is performed under a hydrogen atmosphere at a temperature of about 150° C. to about 500° C.

17. The method of claim 13, wherein the second heat treatment is performed under an air atmosphere at a temperature of about 200° C. to about 500° C.

18. A membrane-electrode assembly for a fuel cell, comprising
a cathode and an anode facing each other; and
a polymer electrolyte membrane between the cathode and anode,
wherein the cathode and the anode respectively includes an electrode substrate and a catalyst layer disposed on the electrode substrate and comprising the catalyst of claim 1.
